(19) United States
(12) Patent Application Publication
(10) Pub. No.: US 2006/0262673 A1
(43) Pub. Date: Nov. 23, 2006

(54) Calibration of fine actuator of optical drive

(76) Inventor: D. Mitchel Hanks, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/133,916

(22) Filed: May 20, 2005

(51) Int. Cl. G11B 7/00

(52) U.S. Cl. 369/44.11

(57) ABSTRACT

A known current is applied to the fine actuator for an optical mechanism of an optical drive. The distance that the optical mechanism radially travels in relation to a data side of an optical disc, in response to the applying of the known current, is determined. The fine actuator is calibrated based on the distance that the optical mechanism radially traveled and the known current.

### BACKGROUND

Many types of optical discs include a data region and a label region. The data region is the portion of the disc where the data is written to, whereas the label region is the portion of the disc where the user may label the disc. For some discs, the data region may be the data side of the disc, while the label region may be the label side opposite the data side. A laser or another type of optical beam can be used to read from and/or write to the data side and the label side of an optical disc. For example, in the patent application entitled “Integrated CD/DVD Recording and Label” [attorney docket 10011728-1], filed on Oct. 11, 2001, and assigned Ser. No. 09/976,877, a type of optical disc is disclosed in which a laser or other optical beam can be used to write to the label side of an optical disc.

The data side of an optical disc typically has one spiral track or a number of concentric tracks preconstructed thereon in the form of grooves. Therefore, an optical drive is able to employ a feedback-type process, such as a closed loop-type process, to ensure that it is properly following a track when writing data to or reading data from the track. However, the label side of an optical disc, such as the label side of the optical disc described in the patent application assigned Ser. No. 09/976,877, usually does not have any preformed tracks. As a result, it can be difficult to properly follow a desired spiral or concentric course when writing to the label side of such an optical disc.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated.

FIG. 1 is a diagram of an optical drive, according to an embodiment of the invention.

FIGS. 2A and 2B are diagrams of the data side and the label side of an optical disc, respectively, according to an embodiment of the invention.

FIG. 3 is a diagram depicting how radial movement of an optical mechanism of an optical drive in relation to the data side of an optical disc can be detected to calibrate a fine actuator of the optical drive for controlling subsequent radial movement of the optical mechanism in relation to the label side of the optical disc, according to an embodiment of the invention.

FIGS. 4A and 4B are diagrams depicting example linear and non-linear calibrations, respectively, of the fine actuator of an optical drive using the approach depicted in FIG. 3, according to an embodiment of the invention.

FIG. 5 is a flowchart of a method for calibrating the fine actuator of an optical drive based on detecting radial movement of the optical mechanism of the optical drive in relation to the data side of an optical disc, and for optically writing to the label side of the optical disc using the fine actuator as has been calibrated, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

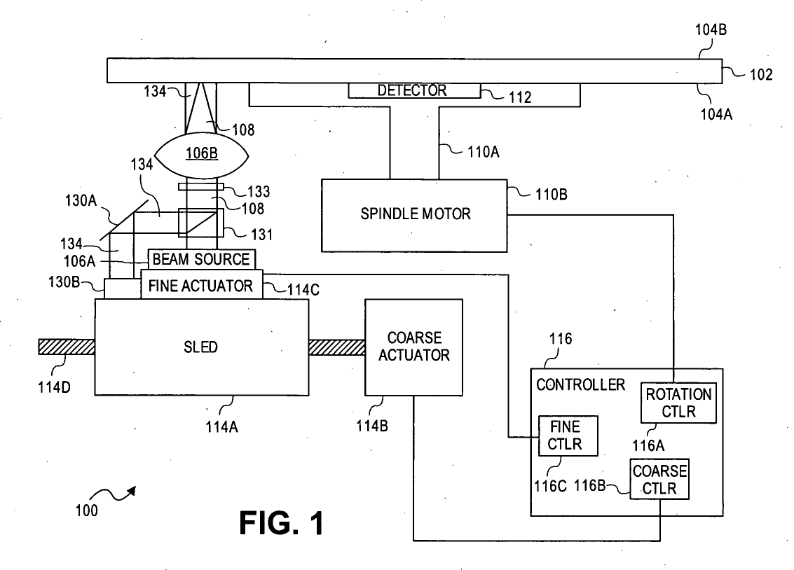

FIG. 1 shows a representative optical drive 100, according to an embodiment of the invention. The optical drive 100 is for reading from and/or writing to an optical disc 102 which has a label side opposite the data side. More specifically, the optical drive 100 is for reading from and/or writing to an optically writable label side 104A of the optical disc 102, and/or an optically writable label side 104B of the optical disc 102, which are collectively referred to as the sides 104 of the optical disc 102. As depicted in FIG. 1, the optical drive 100 is ready for reading from and/or writing to the label side 104A of the optical disc 102. For the optical drive 100 to read from and/or write to the data side 104B of the optical disc 102, the optical disc 102 would have to be turned over, so that the data side 104B is oriented upwards and the label side 104A is oriented downwards.

The optical drive 100 is depicted in FIG. 1 as including a beam source 106A and an objective lens 106B, which are collectively referred to as the optical mechanism 106. The beam source 106A generates an optical beam 108 that passes through a polarizing beam splitter 131 and a quarter wave plate 133, and is focused by the objective lens 106B onto the optical disc 102. The quarter wave plate 133 rotates the polarization of the optical beam 108 as it passes through the plate 133. The optical beam 108 passes through the polarizing beam splitter 131, and is not reflected by the beam splitter 131, because the beam splitter 131 is tuned so that it passes the optical beam 108. That is, the polarization of the optical beam 108 upon initial generation by the optical beam source 108 is such that that the beam splitter 131 does not reflect the beam 108. The optical beam source 106A may be a laser beam source, such that the optical beam 108 is a laser beam. The optical beam 108 may be reflected off the data side 104B of the optical disc 102, which is indicated as the reflected beam 134. The reflected beam 134 has its polarization rotated again as it passes back through the plate 133.

As a result, the reflected beam 134 ultimately has a polarization that is different than the polarity of the initial beam 108 and to which the polarizing beam splitter 131 is tuned such that the beam splitter 131 does reflect the reflected beam 134. In particular, the reflected beam 134 is directed, or reflected, by the beam splitter 131 to one or more mirrors 130A, which direct the reflected beam 134A to a photodetector 130B. The photodetector 130B may be a photodiode, and measures or detects the strength of the reflected beam 134. The mirrors 130A and the photodetector 130B are collectively referred to as the detection mechanism 130. The detection mechanism 130 can be considered as the mechanism that detects whether the optical mechanism 106 is centered on data tracks that have been preformed on the data side 104B of the optical disc 102, as is described in more detail later in the detailed description. It is noted that both the optical mechanism 106 and the detection mechanism 130 may each include other components besides those depicted in FIG. 1, and in some embodiments of the invention each or both may be considered as including the polarizing beam splitter 131 and the quarter wave plate 133.

The optical drive 100 is also depicted in FIG. 1 as including a spindle 110A and a spindle motor 110B, which are collectively referred to as the first motor mechanism 110. The spindle motor 110B rotates the spindle 110A, such that the optical disc 102 correspondingly rotates. The first motor mechanism 110 may include other components besides those depicted in FIG. 1. For instance, the first motor mechanism 110 may include a rotary encoder or another type of encoder to provide for control of the spindle motor 110B and the spindle 110A.

The optical drive 100 also includes a detector 112 situated near or at the spindle 110A. The detector 112 is for detecting alignment marks preformed on the inside circumference of the label side 104A of the optical disc 102, as is described in more detail later in the detailed description. The detector 112 may include an optical light source and an optical detector, in one embodiment of the invention. Alternatively, the detector 112 may include other components.

The optical drive 100 is also depicted in FIG. 1 as including a sled 114A, a coarse actuator 114B, a fine actuator 114C, and a rail 114D, which are collectively referred to as the second motor mechanism 114. The coarse actuator 114B is or includes a motor that causes the sled 114A, and hence the fine actuator 114C and the optical mechanism 106 situated on the sled 114A, to move radially relative to the optical disc 102 on the rail 114D. The coarse actuator 114B thus provides for coarse or large movements of the fine actuator 114C and the optical mechanism 106.

By comparison, the fine actuator 114C also is or includes a motor, and causes the optical mechanism 106 to move radially relative to the optical disc 102 on the sled 114A. The fine actuator 114C thus provides for fine or small movements of the optical mechanism 106. The second motor mechanism 114 may include other components besides those depicted in FIG. 1. For instance, the second motor mechanism 114 may include a linear encoder or another type of encoder to provide for control of the coarse actuator 114B and the sled 114A.

The optical drive 100 is further depicted in FIG. 1 as including a controller 116. The controller 116 is made up of at least a rotation controller 116A, a coarse controller 116B, and a fine controller 116C. The mechanisms 116 may each be implemented in software, hardware, or a combination of software and hardware. The rotation controller 116A controls movement of the spindle motor 110B, and thus controls rotation of the optical disc 102 on the spindle 110A, such as the angular velocity of the rotation of the optical disc 102. The coarse controller 116B controls the coarse actuator 114B, and thus movement of the sled 114A on the rail 114D. The fine controller 116C controls the fine actuator 114C, and thus movement of the beam source 106A on the sled 114A.

Furthermore, the fine controller 116C may be the calibration mechanism for the fine actuator 114C, to calibrate the fine actuator 114C, as is described in more detail later in the detailed description. The controller 116 may further include other components besides those depicted in FIG. 1. For instance, the controller 116 can be responsible for turning on and off, and focusing, optical the beam 108, via control of the beam source 106A and the objective lens 106B. In addition, as can be appreciated by those of ordinary skill within the art, the components depicted in the optical drive 100 are representative of one embodiment of the invention, and do not limit all embodiments of the invention.

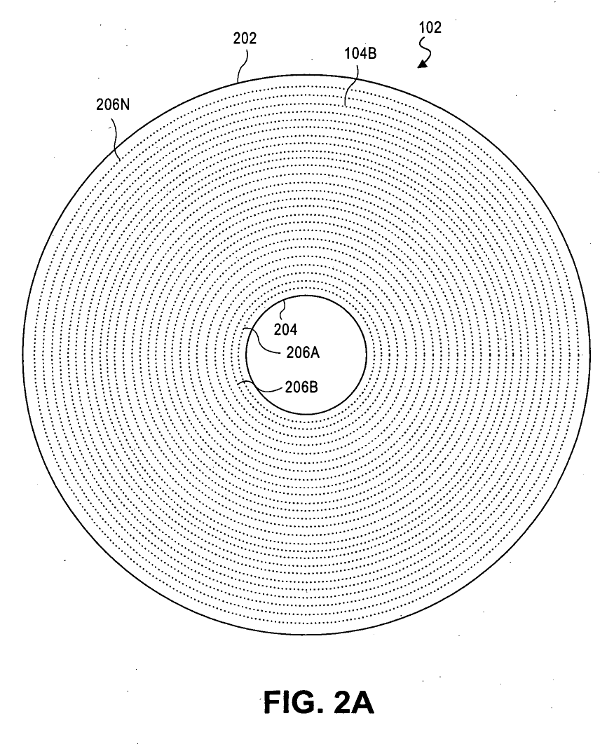

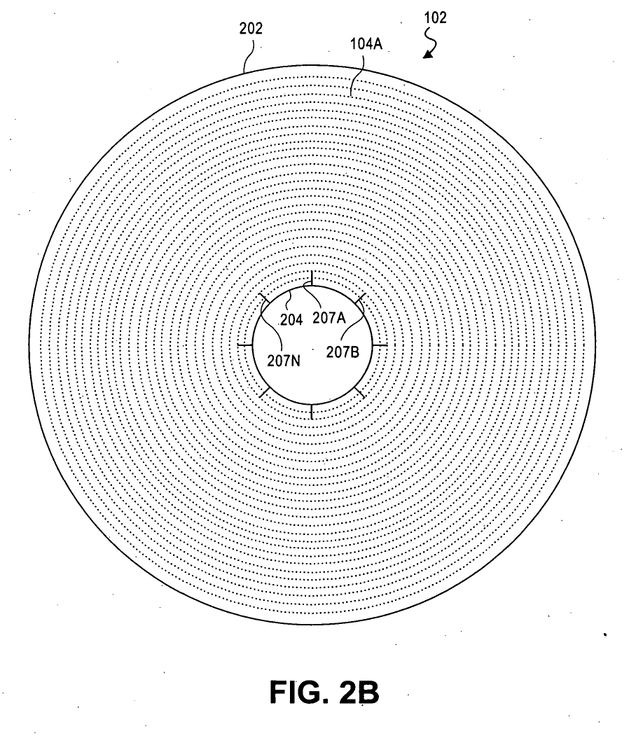

FIG. 2A shows the data side 104B of the optical disc 102 in detail, according to an embodiment of the invention. The optical disc 102 has an inside circumference 204 and an outside circumference 202. The data side 104B is the side of the optical disc 102 to which binary data readable by the optical drive 100 and understandable by a computing device is written, and can be written by the optical drive 100 itself. For instance, the data side 104B may be the data side of a compact disc (CD), a CD-readable (CD-R), which can be optically written to once, a CD-readable/writable (CD-RW), which can be optically written to multiple times, and so on. The data side 104B may further be the data side of a digital versatile disc (DVD), a DVD-readable (DVD-R), or a DVD that is readable and writable, such as a DVD-RW, a DVD-RAM, or a DVD+RW.

The data side 104B has preformed thereon a number of data tracks 206A, 206B, . . . , 206N, extending from the inside circumference 204 to the outside circumference 206, and collectively referred to as the tracks 206. The tracks 206 are preformed on the data side 104B in that they are physical grooves and/or pits etched into the data side 104B during manufacture of the optical disc 102, and are not formed by the optical drive 100 itself. The tracks 206 are depicted as concentrically circular tracks, or rings, in FIG. 2A, but in another embodiment, the tracks 206 may be different portions of a single spiral track extending from the inside circumference 204 to the outside circumference 206.

The preformed tracks 206 enable closed-loop or feedback radial positioning of the optical mechanism 106 relative to the tracks 206. For example, the data side 104B will reflect the beam 108 differently depending on whether the beam 108 is centered on one of the tracks 206. For a digital control loop embodiment, if the reflected beam 134 detected by the detection mechanism 130 indicates that the beam 108 is not centered on one of the tracks 206, then the radial position of the optical mechanism 106 can be adjusted, such as being able to be servoed. The reflected beam 134 is again detected to determine if the beam 108 is now centered on one of the tracks 206. If not, such an iterative process may be repeated until the beam 108 is centered on one of the tracks. This iterative process is a feedback, or a closed-loop, process in that the detection of the reflected beam 134 by the detection mechanism 130 provides feedback, and closes the loop, as to whether the optical mechanism 106 is properly positioned radially relative to the tracks 206 such that the beam 108 is centered on one of the tracks 206. Alternatively, an analog control loop embodiment can be employed, in which an analog feedback compensator is employed that provides feedback which is more continuous than the iterative feedback of the digital control loop embodiment, as can be appreciated by those of ordinary skill within the art.

FIG. 2B shows the label side 104A of the optical disc 102 in detail, according to an embodiment of the invention. The optical disc 102 again has the inside circumference 204 and the outside circumference 206. The label side 104A is the side of the optical disc 102 to which visible markings can be optically written to realize a desired label image. For instance, the label side 104A may be part of an optical disc that is disclosed in the previously filed patent application assigned Ser. No. 09/976,877, which discloses an optically writable label side of an optical disc. In order for an image to be optically written on the label side 104A, the optical mechanism 106 of FIG. 1 traces a path over the surface of the label side 104A, and selectively writes marks to pixels of the label side 104A in accordance with this image.

On the label side 104A, around the inside circumference 204, are a number of alignment marks 207A, 207B, . . . , 207N, collectively referred to as the alignment marks 207. The alignment marks 207 are preformed around the inside circumference 204 at equidistant intervals. The alignment marks 207 are preformed in the sense that they are not optically written to the optical disc 102 using the optical drive 100 of FIG. 1. While the alignment marks 207 are depicted in FIG. 2B as being around the inside circumference 204, in another embodiment they may be around the outside circumference 204. Just eight of the alignment marks 207 are shown in FIG. 2B for illustrative clarity. In actuality, there may be many more of the alignment marks 207, such as 88 of the alignment marks 207. Detection of the alignment marks 207 by the detector 112 of the optical drive 100 enables the optical drive 100 to determine the angular position of the optical mechanism 102 relative to the optical disc 102, and/or the angular velocity at which the optical disc 102 rotates. However, detection of the alignment marks 207 does not provide for determining the radial position of the optical mechanism 102 relative to the optical disc 102.

It is noted that the label side 104A does not include any preformed tracks, like those on the data side 104B of the optical disc 102. This means that radial positioning of the optical mechanism 102 of the optical drive 100 relative to the label side 104A of the optical disc 102 cannot be accomplished in a closed-loop, or feedback, manner, as has been described relative to the data side 104B of the optical disc 102. Rather, radial positioning of the optical mechanism 102 relative to the label side 104A is accomplished in an open-loop, non-feedback manner. That is, there is no detection performed to confirm whether the optical mechanism 106 is properly radially positioned relative to the label side 104A, and there is no feedback to the optical drive 100 to verify the radial position of the optical mechanism 106.

Therefore, embodiments of the invention are concerned with calibrating the fine actuator 114C so that adjusting the fine actuator 114C by a given amount results in a more precisely known radial movement of the optical mechanism 106. The fine actuator 114C is typically adjusted by applying a current to it. Ideally, the optical drive 100 is manufactured so that it is known that applying a given current to the fine actuator 114C will cause the optical mechanism 106 to radially move a known and expected distance. However, due to manufacturing tolerances and other factors, the fine actuator 114C of the optical drive 100 may not actually cause the optical mechanism 106 to radially move the expected distance in response to the fine actuator 114C being set with a particular current.

Because radial movement of the optical mechanism 106 relative to the label side 104A of the optical disc 102 is accomplished in an open-loop manner, there is further no way to detect that the optical mechanism 106 has radially moved relative to the label side 104A by the expected distance in response to the fine actuator 114C being set with a given current. (This is unlike the situation with radial movement of the optical mechanism 106 relative to the data side 104B of the optical disc 102, where the closed-loop or feedback manner of such radial movement allows detection of whether the optical mechanism 106 has radially moved relative to the data side 104B by the expected distance.) If the optical mechanism 106 radially moves relative to the label side 104A less than the expected distance in response to the fine actuator 114C being set with a given current, then the image being optically written to the label side 104A may be undesirably compressed in the radial direction. Conversely, if the optical mechanism 106 radially moves relative to the label side 104A more than the expected distance, then this image may be undesirably lengthened or expanded in the radial direction.

In general, embodiments of the invention calibrate the fine actuator 114C by determining the distance that the optical mechanism 106 radially moves relative to the data side 104B of the optical disc 102 in response to applying a known current to the fine actuator 114C, and then using the fine actuator 114C as has been calibrated to control radial movement of the optical mechanism 106 in relation to the label side 104A. That is, embodiments of the invention leverage the closed-loop or feedback operation relative to the data side 104B and apply it to the radial movement of the optical mechanism 106 relative to the label side 104A. By calibrating the fine actuator 114C based on the data side 104B, the fine actuator 114C can then be used to accurately control radial movement of the optical mechanism 106 in relation to the label side 104A, even where such radial movement is accomplished in an open-loop manner.

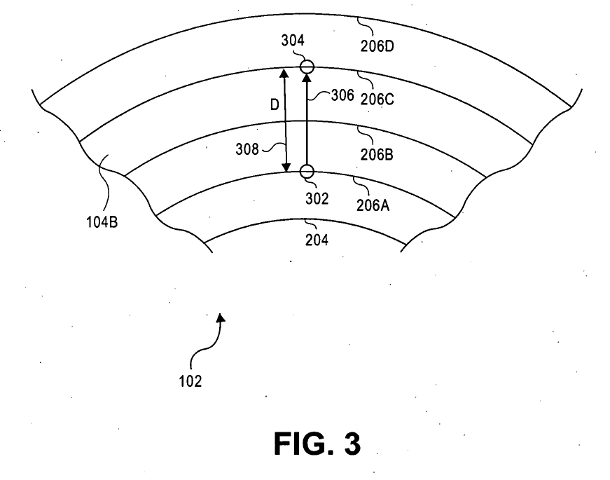

FIG. 3 shows how detected radial movement of the optical mechanism 106 relative to the data side 104B of the optical disc 102, as a result of applying a known current to the fine actuator 114C, can be used to calibrate the fine actuator 114C, according to an embodiment of the invention. A portion of the data side 104B of the optical disc 102 is depicted in FIG. 3, with the concentrically circular tracks 206A, 206B, 206C, and 206D near the inside circumference 204 particularly shown. For example purposes, the optical mechanism 106 is presumed to be initially at the radial position 302 relative to the optical disc 102.

A known current I is next applied to the fine actuator 114C. In response, the optical mechanism 106 moves to the radial position 304 on the data side 104B of the optical disc 102, as indicated by the arrow 306, such that it has moved the distance D, as indicated by the reference number 308. The movement of the optical mechanism 106 is then particularly detected due to the detection of the reflected beam 134 by the photodetector 130B of FIG. 1. That is, the closed-loop or feedback manner by which the optical mechanism 106 radially moves in relation to the data side 104B allows such a radial distance that the optical mechanism 106 radially moves to be detected.

In one embodiment, detection of the reflected beam 134 yields track information encoded within the concentrically circular tracks 206 to yield a determination of the absolute radial position (i.e., the radius) of the optical mechanism 106 relative to the data side 104B. Thus, the track corresponding to the initial radial position 302 of the optical mechanism 106 is first detected, the optical mechanism 106 moves in response to the fine actuator 114C being set with the known current I, and then the track corresponding to the subsequent radial position 304 is detected. The former track radius is subtracted from the latter track radius to yield the distance D. Detection of the reflected beam 134 thus yields the absolute radial position 302 and the absolute radial position 304, which can be differenced to yield the distance D that has been traveled. In this way, the number of the concentrically circular tracks 206 that have been crossed, and thus the distance D, is determined.

In another embodiment, the absolute radial position of the optical mechanism 106 cannot be determined, but the distance that the optical mechanism 106 travels in response to the fine actuator 114C being set with the known current I can be determined. In particular, the number of the concentrically circular tracks 206 crossed is determined by counting the number of sinusoidal high-to-low cycles of the signal provided by the photodetector 130B, which correspond to the number of tracks crossed. The signal provided by the photodetector 130B for this purpose may be a track-crossing signal, which is typically at a maximum when the optical mechanism 106 is centered over a track, and at a minimum when the optical mechanism 106 is centered between two tracks. Alternatively, the signal provided by the photodetector 130B for this purpose may be a tracking-error signal, which is nominally at zero when the optical mechanism 106 is centered over a track, decreases in value as the optical mechanism 106 moves in one direction off track, and increases in value as the optical mechanism 106 moves in the other direction off track. In either case, detection of the reflected beam 134 thus does not yield the absolute radial position 302 nor the absolute radial position 304, but rather just the distance D between the radial positions 302 and 304. In this way, the number of the concentrically circular tracks 206 that have been crossed, and thus the distance D, is determined.

The distance D and the current I are then used to calibrate the fine actuator 114C. Where it is presumed that the distance that the optical mechanism 106 travels is linearly related to the current with which the fine actuator 114C is set, calibration of the fine actuator 114C can be accomplished by setting the fine actuator 114C with one known current, and then detecting the distance that the optical mechanism 106 radially moves in response. Alternatively, the fine actuator 114C may be set with a number of different known currents, and the distances that the optical mechanism 106 radially moves in response may be used to calibrate the fine actuator 114C. For example, more than one such current-distance pair may be used for more accurate linear calibration of the fine actuator 114C, or for non-linear calibration of the fine actuator 114C.

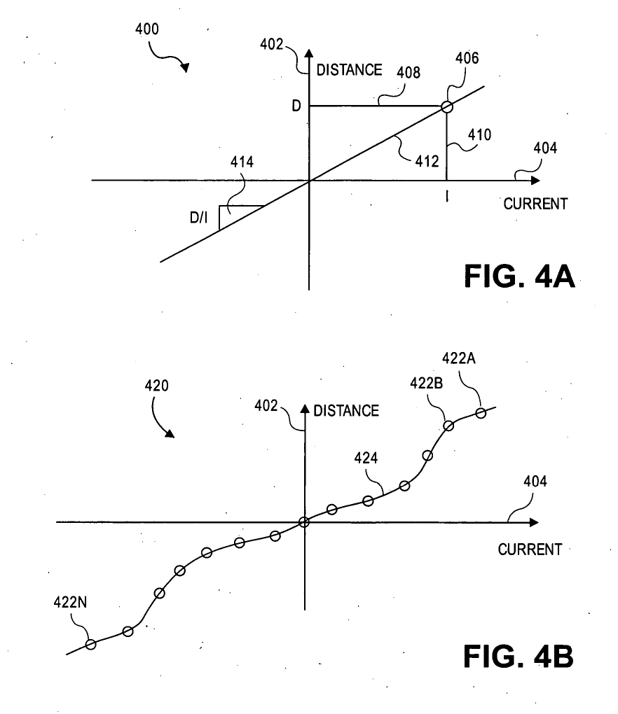

FIG. 4A shows a graph 400 depicting the resulting linear calibration of the fine actuator 114C derived from the distance D that the optical mechanism 106 radially moved in relation to the data side 104B in response to the application of current I to the fine actuator 114C, according to an embodiment of the invention. The y-axis 402 denotes the distance that the optical mechanism 106 radially moves in response to the fine actuator 114C being set with a current, which is denoted by the x-axis 404. The point 406 has the current-distance pair (I, D), where the current I is indicated on the x-axis 404 by the line 410 and the distance D is indicated on the y-axis 402 by the line 408.

The line 412 denoting the distance response by the optical mechanism 106 resulting from the current setting of the fine actuator 114C is constructed from the point 406. In particular, the line 412 intersects the point 406, and has the slope 414 of the distance D over the current I. Thus, the line 412 represents the linear calibration of the fine actuator 114C. When the fine actuator 114C is later used for controlling movement of the optical mechanism 106 in relation to the label side 104A of the optical disc 102, the desired radial distance by which the optical mechanism 106 is to be moved can be looked up on the graph to determine the corresponding current with which the fine actuator 114C should be set to achieved this desired distance.

Alternatively, the graph 400 does not have to be constructed. Rather, a table can be constructed from the distance D and the current I, so that, for any desired distance by which the optical mechanism 106 is to radially move, the needed current for the fine actuator 114C can be looked up. In another embodiment, a mathematical function can be determined in the form current=function (distance), which is the inverse of distance=function (current), so that for a desired distance by which the optical mechanism 106 is to radially move, the needed current for the fine actuator 114C can be determined.

FIG. 4B shows a graph 420 depicting an example non-linear calibration of the fine actuator 114C due to the distances that the optical mechanism 106 radially moves in relation to the data side 104B in response to the fine actuator 114C being set with different known currents, according to an embodiment of the invention. The y-axis 402 again denotes the distance that the optical mechanism 106 radially moves in response to the fine actuator 114C being set with a current, which is again denoted by the x-axis 404. A number of points 422A, 422B, . . . , 422N, collectively referred to as the points 422, are plotted on the graph 420. Each of the points 422 represents the actual detected distance that the optical mechanism 106 radially moved in response to the fine actuator 114C being set with a given known current.

Once the points 422 have been plotted on the graph 420, the line 422 representing the non-linear calibration of the fine actuator 114C can be constructed. Known iterative or non-iterative line-mapping or function-mapping routines can be used, for instance, to construct the line corresponding to the function that yields the points 422 plotted on the graph 420. Alternatively, a table can be constructed from the multiple current-distance pairs that have been collected, or a mathematical function, without constructing a graph, can be determined from these multiple current-distance pairs. The embodiment of FIG. 4B, in which multiple current-distance pairs are plotted, can be advantageous over the embodiment of FIG. 4A, in which just a single current-distance pair is plotted, in applications where the fine actuator 114C does not perfectly linearly control the radial movement of the optical mechanism 106 in response to the current applied to the fine actuator 114C.

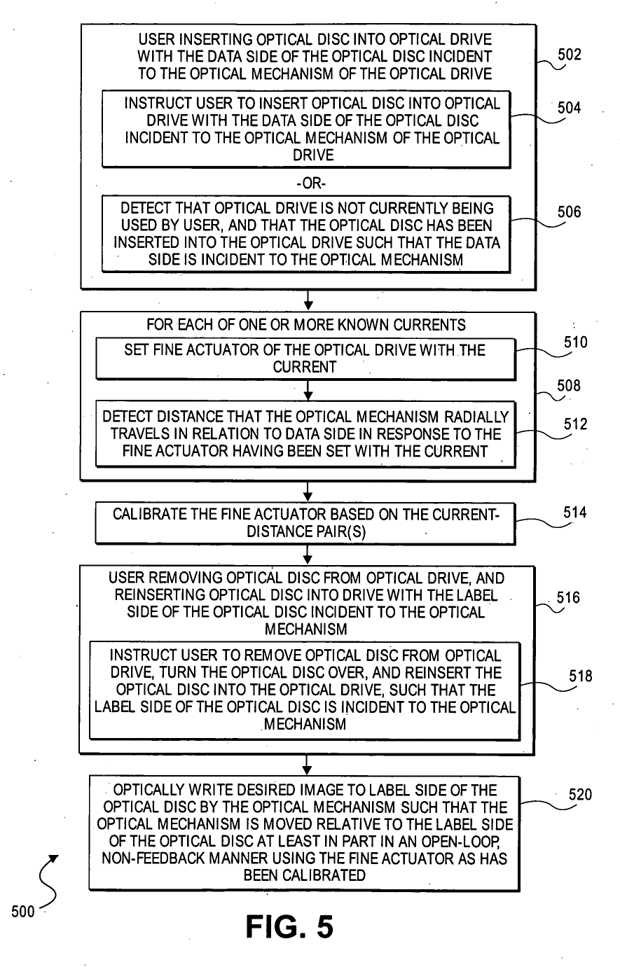

FIG. 5 shows a method 500 for calibrating the fine actuator 114C of the optical drive 100, and for optically writing a desired image on the label side 104A of the optical disc 102, according to an embodiment of the invention. The method 500 may thus be performed by the components of the optical drive 100 that are shown in and have been described in relation to FIG. 1. At least some parts of the method 500 may be implemented as computer program parts of a computer program stored on a computer-readable medium. The medium may be a magnetic storage medium, such as a hard disk drive, an optical storage medium, such as an optical disc, and/or a semiconductor storage medium, such as a memory, among other types of computer-readable media. Calibration of the fine actuator 114C using a portion of the method 500 may be performed before the first time the optical drive 100 is used, in one embodiment. As another example, the user may be requested to perform the calibration process after every predetermined number of optical discs have had their label sides optically written to, and so on.

A user inserts the optical disc 102 into the optical drive 100 with the data side 104B of the optical disc 102 incident to the optical mechanism 106 of the optical drive 100 (502). Performance 502 can include performance of 504 or 506 as well. For instance, the user may be instructed to so insert the optical disc 102 into the optical drive 100 such that the data side 104B is incident to the optical mechanism 106 (504). As another example, the method 500 may detect that the optical drive 100 is not currently being used by the user, and that the optical disc 102 has been inserted into the optical drive 100 with the data side 104B incident to the optical mechanism 106 (506).

The calibration process that has been described in relation to FIGS. 3 and 4A-4B is now performed. For each of one or more known currents (508), 510 and 512 are performed. The currents may be predetermined currents, and in one embodiment may be expressed as a number of digital-to-analog (DAC) converter units or counts corresponding to the currents, as can be appreciated by those of ordinary skill within the art. Each known current can have a known magnitude and a known sign. This is because positive currents may cause the fine actuator 114C to radially move the optical mechanism 106 in one direction, whereas negative currents may cause the fine actuator 114C to radially move the optical mechanism 106 in the opposite direction.

For each known current, then, the current is applied to the fine actuator 114C (510), and the distance that the optical mechanism 106 radially travels in relation to the data side 104B of the optical disc 102 in response to the fine actuator 114C having been set with this current is detected (512). The result is thus a collection of one or more known current-detected distance pairs. The detected distances may be expressed in the number of data tracks 206 that the optical mechanism 106 has passed resulting from the fine actuator 114C having been set with the known currents. The fine actuator 114C is calibrated based on these known current-detected distance pairs (514), such as has been described in relation to FIGS. 4A and 4B.

Calibration of the fine actuator 114C can be linear, as in FIG. 4A, or non-linear, as in FIG. 4B. With linear calibration in particular, where one known current-detected distance pair has been collected, a desired radial travel distance of the optical mechanism 106 can be achieved by setting the fine actuator 114C with a current equal to the desired travel distance, multiplied by the known current, and divided by the detected distance. More generally, for either linear or non-linear calibration, a graph or profile may be constructed, such as depicted in FIGS. 4A and 4B. Alternatively or additionally, a mathematical function characterizing the distances radially traveled by the optical mechanism 106 based on the currents with which the fine actuator 114C has been set may be determined. Alternatively or additionally still, a table providing the currents with which the fine actuator 114C should be set to realize desired radial travel distances by the optical mechanism 106 may be constructed.

Next, if the optical disc is such that the label side is on the opposite side of the media from the data side, the user removes the optical disc 102 from the optical drive 100, and reinserts the optical disc 102 into the optical drive 100 with the label side 104A of the optical disc 102 incident to the optical mechanism 106 (516). This may include instructing the user to remove the optical disc 102 from the optical drive 100, turning it over, and reinserting the optical disc 102 back into the optical drive 100, so that the label side 104A is incident to the optical mechanism 106 (518). The optical mechanism 106 can then optically write a desired image to the optically writable label side 104A of the optical disc 102 (520).

For the optical mechanism 106 to optically write a desired image to the label side 104A, it is moved relative to the label side 104A of the optical disc 102 at least in part in an open loop, non-feedback manner, as has been described, such that the fine actuator 114C as has been calibrated is employed. Thus, movement of the optical mechanism 106 when optically writing to the label side 104A is accurately controlled via the fine actuator 114C, even though such movement is accomplished without confirmation or verification in an open-loop, non-feedback manner, since the fine actuator 114C has been calibrated. The beam source 106A is controllably activated and applied through the optical components to the label side 104A, in coordination with the rotation of the disc 102 and the radial movement of the sled 114A, at the appropriate times and in the appropriate manner as to form the desired visible image on the label side 104A.

It is noted that, although specific embodiments have been illustrated and described herein, it will be appreciated by those of ordinary skill in the art that any arrangement calculated to achieve the same purpose may be substituted for the specific embodiments shown. This application is intended to cover any adaptations or variations of the disclosed embodiments of the present invention. Therefore, it is manifestly intended that this invention be limited only by the claims and equivalents thereof.

I claim:

1. A method for calibrating a fine actuator for an optical mechanism of an optical drive comprising:
applying a known current to the fine actuator;
detecting a distance that the optical mechanism radially travels in relation to a data side of an optical disc in response to the applying of the known current; and,
calibrating the fine actuator based on the distance that the optical mechanism radially traveled and the known current.

2. The method of claim 1, wherein applying the known current to the fine actuator comprises applying the known current, having a known magnitude and a known sign, to the fine actuator.

3. The method of claim 2, wherein detecting the distance that the optical mechanism radially travels in relation to the data side of the optical disc comprises detecting an amount of the distance and a direction of the distance that the optical mechanism radially travels in relation to the data side of the optical disc resulting from the known current having the known magnitude and the known sign having been applied to the fine actuator.

4. The method of claim 1, wherein applying the known current to the fine actuator comprises setting the fine actuator with a number of digital-to-analog converter (DAC) units corresponding to the known current.

5. The method of claim 1, wherein detecting the distance that the optical mechanism radially travels in relation to the data side of the optical disc comprises detecting a number of data tracks of the data side of the optical disc that the optical mechanism has passed.

6. The method of claim 1, wherein calibrating the fine actuator based on the distance that the optical mechanism radially traveled and the known current comprises linearly calibrating the fine actuator, such that a desired travel distance of the optical mechanism is achieved by applying a current to the fine actuator equal to the desired travel distance, multiplied by the known current, and divided by the distance that the optical mechanism radially traveled as detected.

7. The method of claim 1, further comprising:
for each of a plurality of additional known currents,
applying the additional known current to the fine actuator;
detecting a distance that the optical mechanism radially travels in relation to a data side of an optical disc in response,
wherein calibrating the fine actuator is further based on the distance that the optical mechanism radially traveled for each additional known current, and on each additional known current.

8. The method of claim 7, wherein calibrating the fine actuator comprises constructing at least one of: a non-linear actuator profile, a function characterizing optical mechanism distance based on actuator current, or a table providing the actuator current based on desired optical mechanism distance to be traveled.

9. The method of claim 1, further comprising optically writing to a label side of the optical disc by the optical mechanism, such that the optical mechanism is at least partially moved relative to the label side of the optical disc in an open-loop, non-feedback manner using the fine actuator as has been calibrated.

10. The method of claim 1, further comprising initially instructing a user to insert the optical disc into the optical drive with the data side of the optical disc incident to the optical mechanism.

11. The method of claim 10, further comprising instructing the user to remove the optical disc from the optical drive, turn the optical disc over, and reinsert the optical disc into the optical drive with a label side of the optical disc incident to the optical mechanism, for optically writing to the label side of the optical disc by the optical mechanism to occur.

12. A method for labeling an optical disc, comprising:
positioning the optical disc in an optical drive such that a track-based region of the optical disc is incident to an optical mechanism of the optical drive;
for each of one or more known currents,
applying the known current to a fine actuator of the optical drive;
detecting a distance that the optical mechanism radially travels in relation to the track-based region of the optical disc resulting from the application of the known current to the fine actuator;
calibrating the fine actuator based on each known current and the corresponding distance that the optical mechanism radially traveled for each known current;
repositioning the optical disc in the optical drive such that a trackless region of the optical disc is incident to the optical mechanism; and,
optically writing to the trackless region by the optical mechanism, such that the optical mechanism is at least partially moved relative to the trackless region in an open-loop, non-feedback manner using the calibrated fine actuator.

13. The method of claim 12, wherein detecting the distance that the optical mechanism radially travels in relation to the data side of the optical disc comprises detecting a number of data tracks of the data side of the optical disc that the optical mechanism has passed resulting from the application of the known current to the fine actuator.

14. The method of claim 12, wherein calibrating the fine actuator comprises linearly calibrating the fine actuator based on a single known current and the distance that the optically mechanism radially traveled in relation to the data side of the optical disc resulting from the application of the single known current to the fine actuator.

15. The method of claim 12, wherein calibrating the fine actuator comprises non-linearly calibrating the fine actuator.

16. An optical drive comprising:
an optical mechanism to at least write to at least a label side of the optical disc, the optical mechanism being movably positionable relative to the optical disc in a radial manner;
a detection mechanism to detect whether the optical mechanism is centered on data tracks preformed on a data side of the optical disc;
a fine actuator for the optical mechanism to cause the optical mechanism to finely move radially relative to the optical disc in response to being set with a current; and,
a calibration mechanism to calibrate the fine actuator for writing to the label side of the optical disc based on a number of the data tracks that the optical mechanism passed for each of one or more known currents with which the fine actuator was set.

17. The optical drive of claim 16, wherein the optical mechanism is further to read from at least the data side of the optical disc.

18. The optical drive of claim 16, wherein the fine actuator is settable with a current expressed in a number of digital-to-analog converter (DAC) counts.

19. The optical drive of claim 16, wherein the calibration mechanism is to calibrate the fine actuator when the optical drive is not currently being used by a user, the optical disc has been inserted into the optical drive, and the data side of the optical disc is incident to the optical mechanism.

20. The optical drive of claim 16, wherein the calibration mechanism is to calibration the fine actuator at least before a first time the optical drive is used, where a user is instructed to insert the optical disc into the optical drive such that the data side of the optical disc is incident to the optical mechanism.

21. The optical drive of claim 16, wherein the calibration mechanism is to perform one of a linear and a non-linear calibration.

22. An optical drive comprising:
an optical mechanism to at least write to at least a label side of the optical disc, the optical mechanism being movably positionable relative to the optical disc in a radial manner;
a detection mechanism to detect whether the optical mechanism is centered on data tracks preformed on a data side of the optical disc;
a fine actuator for the optical mechanism to cause the optical mechanism to finely move radially relative to the optical disc in response to being set with a current; and,
means for calibrating the fine actuator for writing to the label side of the optical disc based on a number of the data tracks that the optical mechanism passed for each of one or more known currents with which the fine actuator was set.

23. A computer-readable medium having a computer program stored thereon comprising:
a first computer program part to set a fine actuator of an optical drive with each of one or more known currents in succession, an optical disc having been inserted into the optical drive such that a data side of the optical disc is incident to an optical mechanism of the optical drive;
a second computer program part to determine a number of data tracks of the data side of the optical disc in relation to which the optically mechanism radially travels for each known current with which the fine actuator was set; and,
a third computer program part to calibrate the fine actuator based on the number of data tracks of the data side of the optical disc in relation to which the optical mechanism has radially traveled for each known current with which the fine actuator was set, and on each known current with which the fine actuator was set.

24. The computer-readable medium of claim 23, the computer program further comprising:
a computer program part to instruct a user to insert the optical disc into the optical drive such that the data side of the optical disc is incident to the optical mechanism, to remove the optical disc from the optical drive, and to reinsert the optical disc into the drive such that a label side of the optical disc is incident to the optical mechanism,
so that an image can be optically written to the label side of the optical disc with the optical mechanism being at least partially radially moved using the fine actuator as has been calibrated.

25. The computer-readable medium of claim 23, the computer program further comprising a computer program part to optically write an image to the label side of the optical disc with the optical mechanism being at least partially radially moved using the fine actuator as has been calibrated.
